(19) United States
(12) Patent Application Publication
(10) Pub. No.: US 2026/0089557 A1
(43) Pub. Date: Mar. 26, 2026

(54) RADIO LINK CONTROL FOR LATENCY-SENSITIVE SERVICES

(71) Applicant: Meta Platforms Technologies, LLC, Menlo Park, CA (US)

(72) Inventors: Liwen YU, Santa Clara, CA (US); Zhu JI, Cupertino, CA (US); Curt WONG, Bellevue, WA (US)

(73) Assignee: Meta Platforms Technologies, LLC, Menlo Park, CA (US)

(21) Appl. No.: 19/177,467

(22) Filed: Apr. 11, 2025

Related U.S. Application Data
(60) Provisional application No. 63/633,603, filed on Apr. 12, 2024.

(51) Int. Cl. H04W 28/04; H04L 1/18; H04W 28/06

(52) U.S. Cl. CPC H04W 28/04; H04L 1/18; H04W 28/06

(57) ABSTRACT

The disclosure is directed to systems and methods for radio link control for latency service services using error protection encoding and RLC retransmission configurations of PDUs based on PDU types. The solutions can include a device. The device can include one or more processors configured to determine whether a protocol data unit (PDU) of an extended reality (XR) application to be transmitted via a radio link control (RLC) layer corresponds to a low-loss traffic or a loss-tolerant traffic. The device can encode the PDU for error protection, according to the determination. The device can select, from a plurality of configurations for retransmission, a configuration for retransmission of the PDU, according to the determination.

This application claims the benefit of and priority to U.S. Application No. 63/633,603, filed Apr. 12, 2024, the contents of which are incorporated herein by reference in their entirety.

### FIELD OF DISCLOSURE

The present disclosure is generally related to wireless communication between devices, including but not limited to, systems and methods for managing radio link control in an extended reality environment.

### BACKGROUND

Augmented reality (AR), virtual reality (VR), and mixed reality (MR) technologies, collectively extended reality (XR) technologies are becoming more prevalent, as various aspects of the XR is now supported across a wider variety of platforms and device. When communicating XR low-latency data across devices, devices can face latency issues while utilizing acknowledged modes or unacknowledged modes. XR communications however are sensitive to latency and are subject to different delay limitations.

### SUMMARY

When communicating XR low-latency data between different devices, challenges may arise due to the XR technology-related and time-delay constraints, such as the Packet Delay Budget (PDB) or the PDU Set Delay Budget (PSDB). To improve the reliability of the transmitted XR low-latency data, devices may utilize the Acknowledged Mode (AM) of the Radio Link Control (RLC) layer, in which Automatic Repeat Request (ARQ) functionality can be used to provide error correction. However, while ARQ and AM operations can improve data reliability via error correction techniques, these actions can also introduce additional delays, exacerbating the latency issues. An alternative may include utilizing an Unacknowledged Mode (UM) of the RLC layer in which data acknowledgment packets are avoided, thereby reducing latencies at the expense of error correction and data reliability. In order to reliably communicate the low-latency XR data within an acceptable time frame, XR communications may benefit from a solution that combines both the reliability of the AM with the low-latency advantage of the UM, which would result in an improved user experience due to both improved low-latency service and improved reliability.

The technical solutions of this disclosure overcome these above stated technical challenges by introducing encoding and RLC retransmission configurations for different XR traffic types, thereby providing reliable XR data communications within acceptable time frames. The technical solutions can allow for determining the type of XR traffic and encoding of a protocol data unit (PDU) of an XR application for error protection accordingly. For loss-tolerant and low-latency traffic, the system can disable ARQ or sets the number of allowed RLC retransmissions to a predetermined low value, such as one. For low-latency, low-loss and high data rate traffic, the system can use a medium or high code rate for error protection while defining a time interval within the PDB according to which to initiate RLC retransmissions and discarding service data units (SDUs) if their corresponding PDB or PSDB is exceeded. For low-latency, low-loss and low data rate traffic, the system can use a low code rate for error protection while defining the time interval within the PDB for initiating the RLC retransmissions and discarding SDUs past their PDB or PSDB time frames. By tailoring the encoding and the RLC configurations to the specific features of different XR traffic types, the technical solutions allow for a timely and reliable communication, thereby improving the user experience.

In one aspect, the technical solutions of this disclosure relates to a device. The device can include one or more processors coupled with memory. The one or more processors can be configured to determine whether a protocol data unit (PDU) of an extended reality (XR) application to be transmitted via a radio link control (RLC) layer corresponds to a low-loss traffic or a loss-tolerant traffic. The one or more processors can be configured to encode the PDU for error protection, according to the determination. The one or more processors can be configured to select, from a plurality of configurations for retransmission, a configuration for retransmission of the PDU, according to the determination.

The one or more processors can be configured to determine that the PDU corresponds to the loss-tolerant traffic and a low-latency traffic. The one or more processors can be configured to encode, responsive to the determination that the PDU corresponds to the loss-tolerant traffic and the low-latency traffic, the PDU for error protection using a code rate that satisfies a threshold for one of a medium code rate or a high code rate for error protection. The one or more processors can be configured to determine that the PDU corresponds to the loss-tolerant traffic and a low-latency traffic. The one or more processors can be configured to disable, responsive to the determination that the PDU corresponds to the loss-tolerant traffic and the low-latency traffic, automatic repeat request (ARQ) operation of an acknowledged mode (AM) of the RLC layer for error control of transmission of the PDU to a receiving device.

The one or more processors can be configured to determine that the PDU corresponds to the loss-tolerant traffic and a low-latency traffic. The one or more processors can be configured to set, responsive to the determination that the PDU corresponds to the loss-tolerant traffic and the low-latency traffic, the configuration for a number of allowed RLC retransmissions to a predetermined value indicating a maximum number of allowed RLC retransmissions. The predetermined value can be set to one.

The one or more processors can be configured to determine that the PDU corresponds to the low-loss traffic and a high data rate traffic. The one or more processors can be configured to encode, responsive to the determination that the PDU corresponds to the low-loss traffic and the high data rate traffic, the PDU for error protection using a code rate exceeding a threshold for a medium code rate for error protection. The one or more processors can be configured to determine that the PDU corresponds to the low-loss traffic and a high data rate traffic. The one or more processors can be configured to determine a time interval within a packet delay budget (PDB) based on a time duration of the PDB and a number of RLC retransmissions. The one or more processors can be configured to set, responsive to the determination that the PDU corresponds to the low-loss traffic and the high data rate traffic, the configuration to initiate RLC retransmissions according to the time interval. The time interval can be determined by dividing the time duration of the PDB by the number of RLC retransmissions.

The one or more processors can be configured to determine that at least one of the PDB or PDU set delay budget (PSDU) is exceeded for one or more service data units (SDUs) corresponding to one or more PDUs to be transmitted. The one or more processors can be configured to discard, responsive to the at least one of the PDB or PSDU being exceeded, the one or more SDUs. The one or more processors can be configured to determine that a packet data convergence protocol (PDCP) discarded one or more service data units (SDUs) for one or more PDUs to be transmitted. The one or more processors can be configured to discard, responsive to the determination that the PDCP discarded the one or more SDUs, one or more corresponding SDUs at the RLC.

The one or more processors can be configured to determine that the PDU corresponds to the low-loss traffic and a low data rate traffic. The one or more processors can be configured to encode, responsive to the determination that the PDU corresponds to the low-loss traffic and the low data rate traffic, the PDU for error protection using a code rate that satisfies a threshold for a low code rate for error protection. The one or more processors can be configured to determine that the PDU corresponds to the low-loss traffic and a low data rate traffic. The one or more processors can be configured to determine a time interval within a packet delay budget (PDB) based on a time duration of the PDB and a number of RLC retransmissions. The one or more processors can be configured to set, responsive to the determination that the PDU corresponds to the low-loss traffic and the low data rate traffic, the configuration to initiate RLC retransmissions according to the time interval.

The one or more processors can be configured to determine that the PDU corresponds to the low-loss traffic and a low data rate traffic. The one or more processors can be configured to determine that at least one of the PDB or a PDU set delay budget (PSDU) is exceeded for one or more service data units (SDUs) for one or more PDUs to be transmitted. The one or more processors can be configured to discard, responsive to the at least one of the PDB or PSDU being exceeded and the PDU corresponding to the low-loss traffic and the low data rate traffic, the one or more SDUs. The one or more processors can be configured to configure an encoder of the device with an encoding of the PDU for error protection according to the determination. The one or more processors can be configured to synchronize the encoding with a decoder of a receiving device configured to receive the PDU.

In one aspect, the technical solutions of this disclosure relate to a method. The method can include one or more processors determining whether a protocol data unit (PDU) of an extended reality (XR) application to be transmitted via a radio link control (RLC) layer corresponds to a low-loss traffic or a loss-tolerant traffic. The method can include encoding, by the one or more processors, the PDU for error protection, according to the determination. The method can include selecting, by the one or more processors, from a plurality of configurations for retransmission, a configuration for retransmission of the PDU, according to the determination.

The method can include determining, by the one or more processors, that the PDU corresponds to the loss-tolerant traffic and a low-latency traffic. The method can include encoding, by the one or more processors, responsive to the determination that the PDU corresponds to the loss-tolerant traffic and the low-latency traffic, the PDU for error protection using a code rate that satisfies a threshold for one of a medium code rate or a high code rate for error protection. The method can include disabling, by the one or more processors, responsive to the determination that the PDU corresponds to the loss-tolerant traffic and the low-latency traffic, automatic repeat request (ARQ) operation of an acknowledged mode (AM) of the RLC layer for error control of transmission of the PDU to a receiving device.

The method can include determining, by the one or more processors, that the PDU corresponds to the loss-tolerant traffic and a low-latency traffic. The method can include setting, by the one or more processors, responsive to the determination that the PDU corresponds to the loss-tolerant traffic and the low-latency traffic, the configuration for a number of allowed RLC retransmissions to a predetermined value indicating a maximum number of allowed RLC retransmissions. The predetermined value can be a value of one.

The method can include determining, by the one or more processors, that the PDU corresponds to the low-loss traffic and a high data rate traffic. The method can include determining, by the one or more processors, a time interval within a packet delay budget (PDB) based on a time duration of the PDB and a number of RLC retransmissions. The method can include setting, by the one or more processors, responsive to the determination that the PDU corresponds to the low-loss traffic and the high data rate traffic, the configuration to initiate RLC retransmissions according to the time interval. The time interval can be determined by dividing the time duration of the PDB by the number of RLC retransmissions.

The method can include determining, by the one or more processors, that the PDU corresponds to the low-loss traffic and a low data rate traffic. The method can include encoding, by the one or more processors, responsive to the determination that the PDU corresponds to the low-loss traffic and the low data rate traffic, the PDU for error protection using a code rate that satisfies a threshold for a low code rate for error protection. The method can include determining, by the one or more processors, a time interval within a packet delay budget (PDB) based on a time duration of the PDB and a number of RLC retransmissions. The method can include setting, by the one or more processors, responsive to the determination that the PDU corresponds to the low-loss traffic and the low data rate traffic, the configuration to initiate RLC retransmissions according to the time interval.

In one aspect, the technical solutions of this disclosure are directed to a device receiving PDUs from a remote device. The device can include one or more processors. The one or more processors can be configured to receive, from a remote device, information on whether a protocol data unit (PDU) of an extended reality (XR) application to be transmitted via a radio link control (RLC) layer corresponds to a low-loss traffic or a loss-tolerant traffic. The one or more processors can be configured to decode the PDU for error protection, according to the information. The one or more processors can be configured to select, from a plurality of configurations for retransmission, a configuration for a decoder of the device for retransmission of the PDU from the remote device, according to the information.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for providing radio link control for latency sensitive services.

FIG. 6 is a diagram of a traffic flow for providing radio link control for latency service services.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, the systems and methods described herein may implement protocol data unit (PDU) set discarding. A PDU set may include one or more PDUs which carry the payload of a unit of information generated at an application layer of a source device. For example, within the context of extended reality (XR) applications, a PDU may carry a frame or video slice for an XR application. A PDU can enclose or encapsulate payload information that can be provided via a service data unit (SDU). Different PDUs can vary based on their type. For instance, some PDUs may be low-latency and loss-tolerant PDUs, corresponding to low-latency and loss-tolerant traffic. Some PDUs may be low-latency, low-loss and high data rate PDUs corresponding to low-latency, low-loss and high data rate traffic. Some PDUs may be low-latency, low-loss and low data rate PDUs corresponding to low-latency, low-loss and low rate data rate traffic. The technical solutions can configure the encoding and the RLC retransmissions based on the PDU types.

Currently, there can be two operating modes in a 5G new radio (NR) radio link control (RLC). First, an acknowledged mode (AM) mode in radio link control (RLC) can employ a lossless RLC data transmission method by using Automatic Repeat request (ARQ). ARQ can provide an error control and packet recovery technique for data transmission in which the receiver sends an alert to the sender if a packet is missing, so that the sender can resend the missing packet. During an ARQ, the receiver can send acknowledgments for correctly received data blocks and requests retransmission for those with errors. The acknowledged mode can be useful to limit data loss and achieves high reliability. Second, an unacknowledged mode (UM) mode can differ from the AM mode in that the UM mode can be less reliable because the UM mode does not employ ARQ or error correction mechanisms. The UM mode can be used for delay-sensitive applications where a small amount of data loss can be tolerated.

Extended reality (XR) services can be sensitive to latency and have a strict Packet Delay Budget (PDB) as well as a PDU Set Delay Budget (PSDB), with the delay budget being around 30 milliseconds. The RLC AM mode retransmission time can be in the order of 20-30 milliseconds (ms) per attempt, making it challenging for XR applications to meet the PDB and PSDB requirements. Further, the AM mode may address additional factors when determining the applicability to use in XR services, including: window stalling, prioritization rules, triggering of a poll, and feedback status of protocol data unit(s) (PDUs). These functionalities can exacerbate the delays incurred by the AM mode operation.

Regarding window stalling, the RLC entity may maintain a transmitting window. The transmitter may not submit new RLC service data units (SDUs) whose secondary node (SN) falls outside this window. Regarding the prioritization rules, when both acknowledged mode data (AMD) PDUs for retransmission and new transmission are available, the transmitter may prioritize retransmission, which may jeopardize the latency performance of new packets. Regarding, triggering of a poll, the transmitter may trigger a polling bit in an AMD PDU, which can ask the receiver to provide a STATUS PDU that includes ACK/NACK information. An Acknowledgement (ACK) or Negative Acknowledgement (NACK) may include a short message sent by the receiver to the transmitter to indicate whether it has correctly or incorrectly received a data packet. However, polling can only be triggered under certain conditions. Regarding feedback of status PDUs, the STATUS PDU provides ACK/NACK information for the transmitter to move the transmitting window forward when it is possible, but the receiver may not be able to send STATUS PDU in a timely fashion due to mechanisms such as the prohibit timer.

Additional details of the present solution, as well as various technical benefits, are provided in greater detail below.

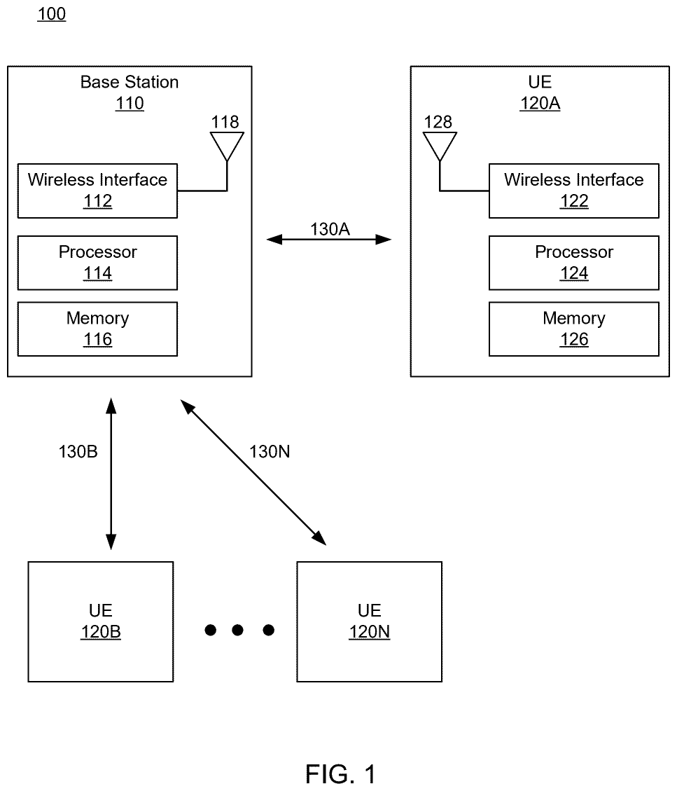

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0-1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

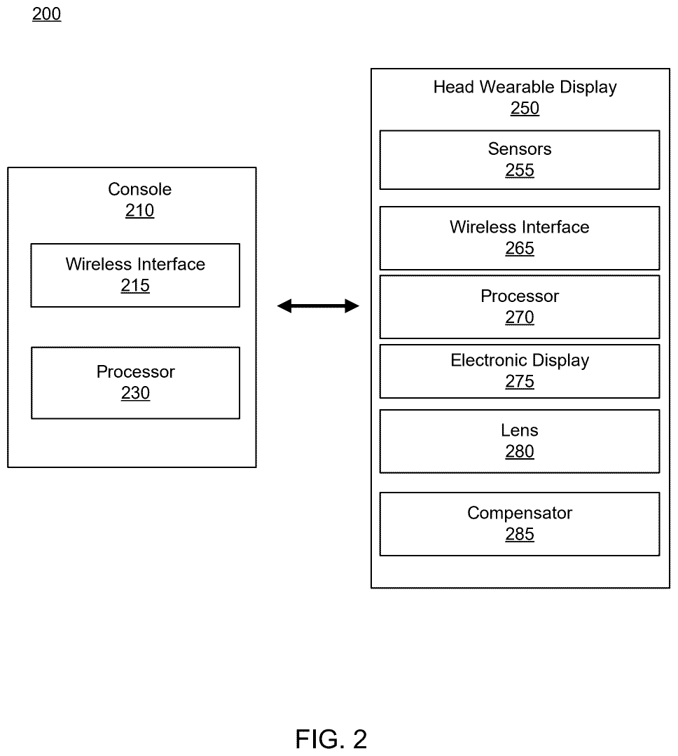

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

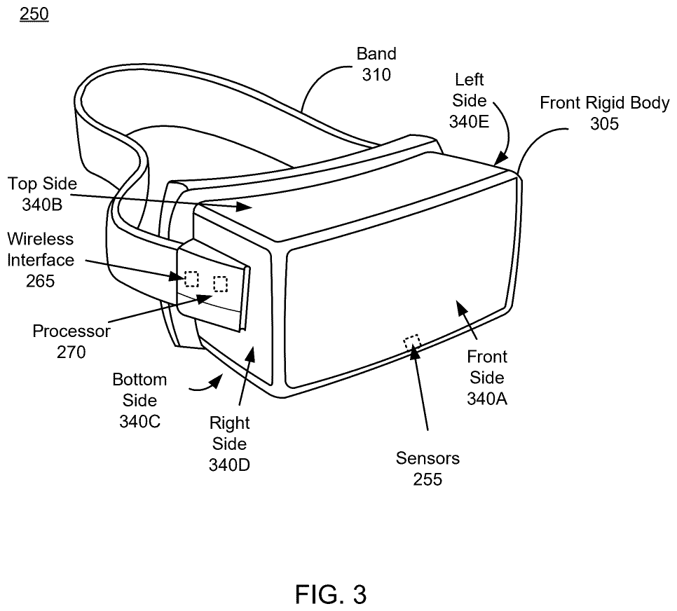

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

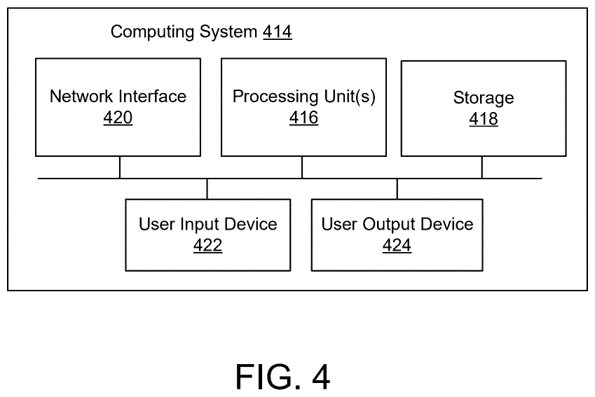

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

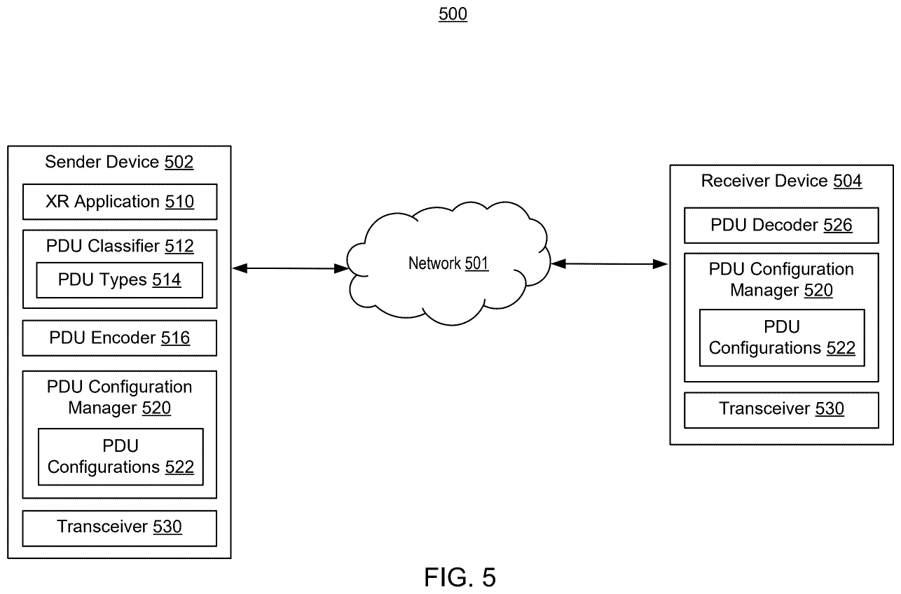

FIG. 5 illustrates a block diagram of an example system 500 for radio link control for latency sensitive services. System 500 can be a system for providing error protection encoding and RLC retransmission configurations for XR application PDUs, based on the types of the PDUs. The system 500 can include a sender device 502, such as a UE 120, console 210 or a head wearable display 250, and a receiver device 504, such as a base station 110, a UE 120, a console 210 or a head wearable display 250. The sender device 502 can communicate with (e.g., transmit data to) the receiver device 504 via a network 501 (e.g., any combination of one or more cellular networks, Wi-Fi networks or the internet). Communications or transmissions exchanged can include, for example, various PDUs of low-latency network traffic, such as traffic of XR applications.

The sender device 502 can include one or more XR applications 510 that can generate various low-latency PDU traffic to be transmitted to the receiver device 504. The sender device 502 can include one or more PDU classifiers 512 to identify or determine the PDU types 514 of the PDU traffic generated by the XR application 510, such as, PDU traffic that is loss-tolerant traffic, low-loss and also high data rate traffic or low-loss and also low data rate traffic. The sender device 502 can include one or more PDU encoders 516 to encode the PDU traffic based on their respective PDU types 514, such as encoding loss-tolerant traffic with medium or high code rate for error protection while encoding low-loss and low data rate traffic with a low code rate for error protection. The sender device 502 can include one or more PDU configuration managers 520 for generating, selecting or establishing PDU configurations 522 to configure RLC retransmissions of the PDU traffic. The sender device 502 can include one or more transceivers 530 for communicating, via the network 501, the PDUs according to their encoding by the PDU encoder 516 and according to their PDU configurations 522 by the PDU configuration manager 520.

Across the network 501, the receiver device 504 can receive the PDUs transmitted from the sender device 502. The receiver device 504 can include one or more PDU decoders 526 for decoding the encoding of the PDUs by the PDU encoder 516. The receiver device 504 can include one or more PDU configuration managers 514 for receiving, communicating, supporting, processing or otherwise managing the received PDUs according to their PDU configurations 522. The receiver device 504, having various circuitry or antenna features, for receiving the PDUs from the sender device 502, via the network 501, as well as transmitting any separate transmissions, such as status PDUs, providing acknowledgements to the sender device 502.

The sender device 502 and the receiver device 504 can include any devices capable of communicating (e.g., transmitting or receiving) PDU traffic. The sender device 502 can include any device capable of utilizing, accessing or executing an XR application 510 and communicating the PDU traffic from the XR application 510 based on its encoding or RLC configurations. The receiver device 504 may similarly include any device capable of receiving the encoded or configured PDU traffic from the sender device 502. Any of the sender device 502 or the receiver device 504 can be, include, or comprise any feature or functionality of any UE 102, base station 110, console 210 or a head wearable display 250. The sender device 502 and the receiver device 504 can each include, utilize, or operate a computing system 414 allowing these devices to perform any functionalities described herein, including performing any RLC communication.

An extended reality application 510, also referred to as an XR application 510, can include any combination of hardware and software providing or delivering low-latency PDU traffic data. XR application 510 can include any application accessed by, utilized by, or operating on a sender 502, and generating any XR data, any mix or combination of AR, VR, or MR traffic. XR applications 510 can include one or more immersive gaming platforms, virtual training environments, remote collaboration tools, and interactive educational programs. The XR application 510 can generate different types of low-latency PDU traffic that is intended to be transmitted efficiently (e.g., within a predetermined time interval or latency) and reliably (e.g., without losses or with losses that are less than an acceptable threshold rate) to provide a seamless user experience.

XR application 510 can generate or produce various types of XR traffic, also referred to as the PDU types 514. PDU types 514 can include any classifications or types of PDUs generated by the XR application 510 and classified or identified based on their specific characteristics or requirements for transmission. The PDU type 514 can include a group of PDUs associated with a type of traffic that is characterized according to its characteristics, such as whether it is low latency or tolerant of latency, whether it is low-loss or loss-tolerant, whether it is high data rate traffic or a low data rate traffic. For instance, a PDU type 514 of an XR application 510 can be a low-latency and loss-tolerant PDU traffic, such as XR video traffic with less importance (e.g., predicted pictures or P frames) than a higher importance video traffic (e.g., intra-coded frames or I frames). For instance, this type of low-latency and loss-tolerant PDU traffic can be encoded with medium or high code rates for error protection (e.g., code rates of 3/4 or 1/2) and may utilize early RLC retransmission or discard strategies (e.g., disabling the RLC ARQ or setting the RLC retransmission attempts to a low predetermined number, such as 1 or 2).

PDU types 514 can also include, for example, a low-loss and high data rate PDU traffic, such as XR videos with high importance (e.g., I frames), which can be more important than lower importance video traffic (e.g., P frames). This PDU type 514 of traffic can be encoded with medium or high code rates for error protection (e.g., code rates of 4/5, 3/4, 2/3 or ½). This PDU type 514 of traffic can be configured according to RLC retransmissions configured based on a PDB time duration (e.g., 20 ms, 30 ms or 40 ms) and a predetermined number of RLC retransmissions. For instance, a time interval for automated retransmissions of this PDU type 514 of traffic can be established based on K time interval in ms defined by time period of PDB of X ms divided by the predetermined or default number of RLC retransmission (N), such as K(ms)=X ms/N, to provide an automatically triggered RLC retransmission of this PDU type 514 within K time interval, ensuring a transmission of the this PDU type 514 within the predetermined delay interval (e.g., PDB).

PDU type 514 can include, for example, traffic that is low-loss and low data rate traffic, such as XR pose or XR control data. This type of traffic can be encoded with low code rates (e.g., code rates of 1/6 or 1/4) and can be configured according to RLC retransmissions determined based on the PDB time duration and the number of RLC retransmissions. For instance, the RLX retransmissions can be automated based on the K time interval defined as K(ms)=X ms/N, to automatically trigger RLC retransmissions of this PDU type 514 according to K time intervals within the predetermined time interval (e.g., PDB). By classifying and encoding the XR PDU traffic based on their respective PDU Types 514, the system 500 can deliver the XR Application 510 data from the sender to the receiver within a predetermined time frame (e.g., PDB or PSDB) satisfying the latency requirements and providing a level of reliability to the transmitted data per RLC PDU configuration 522.

PDU classifier 512 can include any combination of hardware and software for detecting, identifying or determining the PDU types 514 for PDU traffic provided by a XR application 510. PDU classifier 512 can include the functionality to determine whether a PDU of an XR application 510 to be transmitted via an RLC layer corresponds to a low-loss traffic or a loss-tolerant traffic. The PDU classifier 512 can include the functionality to assign PDUs to their particular PDU types 514 based on the format of the traffic (e.g., video frames or control data) or based on characteristics of the traffic (e.g., low-loss, loss-tolerant, high data rate or low data rate traffic). For instance, the PDU classifier 512 can determine that a PDU is a low-latency traffic type by determining that its latency threshold is below a threshold for low latency traffic. For instance, the PDU classifier 512 can determine that a PDU is a high data rate traffic type by determining that its data rate traffic rate is above a threshold for high data rate traffic. For instance, the PDU classifier 512 can determine that a PDU is a low data rate traffic type by determining that its data rate traffic rate is below a threshold for a high data rate traffic. For instance, the PDU classifier 512 can determine that a PDU is a low-loss traffic type by determining that its loss tolerance is below a threshold for loss-tolerance by loss-tolerant traffic. PDU classifier 512 can include rules for assigning PDU types 514 to various PDUs based on whether they satisfy any combination of low-latency, loss-tolerant, low-loss, high data rate or low data rate traffic threshold.

The PDU classifier 512 can determine if the PDU traffic is low-latency and high data rate traffic, such as XR videos with high importance (e.g., I frames), which can utilize encoding with low code rates (e.g., code rates for error protection of about 1/4, 1/5 or 1/8) and specific RLC retransmission configurations. The PDU classifier can identify a PDU type 514, such as a low-latency and low data rate traffic type, corresponding to XR pose or control data of the XR application 510. The which can be encoded with low code rates and configured for RLC retransmissions based on the PDB time duration and the number of allowed retransmissions. Furthermore, PDU classifier 512 can detect and classify XR video traffic with less importance (e.g., P frames) that is loss-tolerant and can be encoded with medium or high code rates for error protection, utilizing early RLC retransmission or discard strategies. By classifying the PDUs based on their PDU types 514, the PDU classifier 512 allows the PDU encoder 516 and the PDU configuration manager 520 to encode and configure the XR PDU data to allow for its efficient and reliable transmission according to the latency and reliability standards sufficient to improve the user experience.

PDU encoder 516 can include any combination of hardware and software for encoding the PDUs of the XR application 510. PDU encoder 516 can include the functionality to encode the PDUs for error protection. The PDU encoder 516 can encode the PDUs for error protection based on or according to the determination of the PDU type 514, such as whether the PDUs characteristics correspond to low-latency, loss-tolerant or low-loss, high data rate or low data rate traffic characteristics. For instance, the encoding of the PDUs for error protection can include assigning, establishing or providing a medium or high code rate (e.g., code rate greater than a code rate threshold) for error protection, such as for example the code rate of 4/5, 3/4 or 1/2, depending on the context and the network traffic type. Such encoding can be provided in response to determining that the PDU type 514 of the PDU corresponds to low-latency and loss-tolerant traffic, or a low-latency, low-loss and high data rate traffic.

The PDU encoder 516 can, for example, encode PDUs for PDU types 514 that correspond to low-loss and low data rate traffic, such as XR pose or control data, using low code rates (e.g., code rates of 1/6 or 1/4) for error protection. The PDU encoder 516 can synchronize the encoding with a PDU decoder 526 of the receiver device 504 to allow for correctly decoding the encoded PDUs upon receiving by the receiver. For instance, the PDU encoder 516 can encode, responsive to the determination that the PDU corresponds to the loss-tolerant traffic and the low-latency traffic, the PDU for error protection using a code rate that satisfies a threshold for one of a medium code rate or a high code rate for error protection (e.g., a predetermined threshold of an error code rate, such as a rate of 1/2, or any other rate established based on the application). For example, the PDU encoder 516 can encode, responsive to the determination that the PDU corresponds to the low-loss traffic and the high data rate traffic, the PDU for error protection using a code rate exceeding a threshold for a medium code rate for error protection. For example, the PDU encoder 516 can encode, responsive to the determination that the PDU corresponds to the low-loss traffic and the low data rate traffic, the PDU for error protection using a code rate that satisfies a threshold for a low code rate for error protection (e.g., rate of less than 1/2 or any other rate established based on the application).

A PDU decoder 526 can include any functionality of a PDU encoder 516 and can be configured to decode the encodings of the PDU encoder 516. The PDU encoder 516 can include any functionality of a PDU decoder 526 and vice versa. Both the sender device 502 and the receiver device 504 can include the PDU encoders 516 and PDU decoders 526, allowing the encoded and RLC retransmission configured PDU transmissions to be encoded and decoded or communicated without errors.

PDU configuration 522 can include any type and form of settings, policies or rules for controlling transmission and handling of PDUs. PDU configuration 522 can include rules or policies for managing RLC retransmissions or discarding PDUs or SDUs based on PDU types 514 of the PDU or based on the delays associated with the PDU transmissions. For example, the PDU configuration manager 520 can set a predetermined number of allowed RLC retransmissions for loss-tolerant and low-latency traffic, setting the maximum number of retransmissions for the given PDU, based on the PDU type 514 of the PDU (e.g., the loss-tolerant and low-latency traffic type). For instance, the PDU configuration manager 520 can determine a time interval within the Packet Delay Budget (PDB) based on the duration of the PDB and the number of RLC retransmissions, and use these values to determine a K interval within the PDB within the RLC retransmissions of the PDUs will be automated according to the K interval(s) in order to meet latency requirements. PDU configurations 522 can establish discarding SDUs when the PDB or PSDBs are exceeded, allowing the resources to not be wasted on retransmitting packets that will not meet the time constraints. The PDU configuration manager 520 can set configurations based on a Packet Data Convergence Protocol treatment of PDUs, triggering discarding of SDUs at the RLC layer had already discarded the corresponding PDUs at the PDCP.

PDU configuration manager 520 can include any combination of hardware and software for configuring, establishing or providing PDU configurations 522 for PDUs of the XR application 510. The PDU configuration manager 520 can provide policies or rules to establish PDU configurations 522 for controlling or setting RLC retransmissions or discarding of SPUs of given the delay of the PDUs. The PDU configuration manager 520 can include the functionality for controlling or setting any PDU configurations 522, such as settings or configurations for controlling or managing RLC retransmissions of the PDUs. The PDU configuration manager 520 can select a PDU configuration 522 from a plurality of PDU configuration 522 to enable or disable various AM mode RLC features, such as ARQ operations for error control of PDU transmissions. The PDU configuration manager 520 can select, set or establish the PDU configurations 522 to define a number of allowed RLC retransmissions to a predetermined value, such as establishing a maximum number of allowed RLC retransmissions for a given PDU, based on the PDU type 514.

The PDU configuration manager 520 can set the PDU configuration 522 for a number of allowed RLC retransmissions to a predetermined value indicating a maximum number of allowed RLC retransmissions. The PDU configuration manager 520 can set such PDU configuration 522 responsive to the determination that the PDU corresponds to the loss-tolerant traffic and the low-latency traffic. In some examples, the PDU configuration manager 520 can utilize the PDU classifier 512 to determine that the PDU corresponds to the low-loss traffic and a high data rate traffic. The PDU configuration manager 520 can then determine a time interval within a packet delay budget (PDB) based on a time duration of the PDB and a number of RLC retransmissions. The time interval can be a K time interval of a particular ms duration. The K time interval can be defined as X time period of the PDB in ms divided by the predetermined number of RLC retransmissions N to transmit each K time interval within the X PDB time period (e.g., automate RLC retransmissions of the PDU according to Kms=X ms/N). In such examples, the PDU configuration manager 520 can set the PDU configuration 522 to initiate RLC retransmissions according to the K time interval that is determined by dividing the time duration of the PDB by the number of RLC retransmissions, in response to the determination, by the PDU classifier 512, that the PDU corresponds to PDU type 514 of the low-loss traffic and the high data rate traffic.

The PDU configuration manager 520 can establish PDU configurations 522 for discarding SPUs associated with PDUs when a determination is made that PDUs will not satisfy set time constraints. For instance, the PDU configuration manager 520 can determine that a set time duration, such as a PDB or an SPDU delay is exceeded or will be exceeded for one or more SDUs corresponding to one or more PDUs to be transmitted. In response to such a determination (e.g., that the PDB or PSDU is to be exceeded) the PDU configuration manager 520 can discard the SDUs corresponding to the PDUs. These PDU configurations 522 for discarding the PDUs or SDUs can be established based on the PDU type 514 (e.g., in response to determining that the PDU type 514 corresponds to a low-latency and low loss type of traffic).

The PDU configuration manager 520 can establish a PDU configuration 522 for discarding PDUs or SDUs based on a packet data convergence protocol (PDCP) treatment of the PDUs. For instance, the PDU configuration manager 520 can determine that PDCP of the stack has discarded, or is to discard, one or more SDUs for one or more PDUs to be transmitted discard. Responsive to such a determination that the PDCP discarded the one or more SDUs, the PDU configuration manager 520 can discard one or more corresponding SDUs at the RLC. This PDU configuration 522 for discarding the PDUs or SDUs can be established based on the PDU type 514 (e.g., in response to determining that the PDU type 514 corresponds to a low-latency and low loss type of traffic).

The PDU configuration manager 520 can include the functionality to coordinate or synchronize the treatment (e.g., encoding or configurations) of the PDUs at the sender device 502 with the PDU decoder 526 or PDU configuration manager 520 of the receiver device 504. The PDU configuration managers 520 of the sender and the receiver can exchange communications (e.g., encoder settings or PDU configurations 522) allowing the recipient of these communications to synchronize or coordinate their processing of data based on the encoder settings or PDU configurations 522 of the sender of the communications. For instance, the PDU configuration manager 520 can receive, monitor or configure a PDU encoder 516 of the sender device 502 with an encoding of the PDU for error protection according to the determination of the PDU type 514 of a PDU being encoded. The PDU configuration manager 520 can synchronize the encoding with a PDU decoder 526 of a receiver device 504 configured to receive the PDU. The PDU configuration managers 520 of the sender device 502 and receiver device 504 can synchronize or coordinate communications between them to maintain communications according to the PDU configurations 522 established by the sender or the receiver (e.g., for its respective transmissions).

The PDU configuration manager 520 can be used to synchronize or coordinate communications between sender and receiver devices in various ways. For example, A PDU configuration manager 420 can receive, from a remote sender device 502, information (e.g., configuration data) on whether a PDU of an XR application 510 to be transmitted via an RLC layer corresponds to a particular PDU type 514. For instance, the message for synchronizing operation between the sender and receiver devices can include information on encoding or configuration of the PDU traffic. For instance, the information can include PDU type information 514, such as information whether the PDU type 514 corresponds to a low-loss traffic or a loss-tolerant traffic. The PDU configuration manager 520 can utilize or trigger a PDU decoder 526 to decode the PDU for error protection, according to the information indicating the encoding and configuration data or indicating the PDU type 514. The PDU configuration manager 520 can select, from a plurality of PDU configurations 522 for retransmission, a configuration for a PDU decoder 526 of the receiver device 504 for retransmission of the PDU from the remote device, according to the information received.

For instance, the PDU decoder 526 and the PDU configuration manager 522 of the receiver device 504 can manage or receive the PDU traffic from the sender device 502 according to the encoding or PDU configurations 522 implemented by the sender device, based on the received configuration or encoding information. For instance, the PDU decoder 526 can decode and manage any errors based on the encodings of the PDU encoder 516 (e.g., manage error protection according to the code rate set by the PDU encoder 516). For instance, the PDU configuration manager 520 of the receiver device 504 can disable the ARQ or set or operate the RLC retransmission attempts as set by the PDU configuration manger 522 of the sender device 502 (e.g., receive early RLC retransmissions per K time interval or determine that no additional SDUs or PDUs are to be received after the PDB or PSDB, per PDU configuration).

The transceiver 530 can include any combination of hardware and software for facilitating the communication of PDUs across the network 501 to the receiver device 504. It encompasses both transmission and reception functionalities, enabling the sender device 502 to send encoded PDUs and receive acknowledgments or status PDUs from the receiver device 504. The transceiver 530 can include various hardware elements such as antennas, amplifiers, and modulators, as well as software components for managing the communication protocols and ensuring efficient data transfer. It operates by transmitting PDUs according to their encoding by the PDU encoder 516 and their configurations set by the PDU configuration manager 520. The transceiver 530 ensures that the PDUs are sent within the specified time intervals and with the appropriate error protection measures, optimizing the reliability and latency of XR data communications. Additionally, the transceiver 530 can receive status PDUs from the receiver device 504, providing feedback on the transmission status and enabling the sender device 502 to adjust its transmission strategies accordingly. By integrating these functionalities, the transceiver 530 plays a vital role in maintaining seamless and efficient communication between the sender and receiver devices, enhancing the overall performance of the XR application 510.

Referring now to an example Table 1 illustrating different PDU types 514 and their corresponding encoding and PDU configurations, as well as example determinations providing the reasoning for the encoding and PDU configurations 522. As indicated in Table 1, solutions to different variants of XR data traffic (e.g., PDUs and SDUs of different types of data) can be provided for a transmission node and receiver node. During transmission between two nodes (e.g., sender and receiver devices) there can be various transmission variations, e.g. low-latency, loss-tolerant traffic, low-loss, high data rate traffic and low data rate traffic, along with any specific combinations of these and other characteristics of the XR application data. In the context of extended reality, each of these transmission variants can be addressed by the solutions that can be configured or tailored for the given combination of PDU/SDU data characteristics.

For instance, as shown in the Table 1, low-latency and loss-tolerant data can be encoded with medium or high code rate for error protection. A medium code rate can be determined based on a threshold or a range, such as between 1/3 and 1/2 code rates, with an understanding that the ranges can vary based on configuration settings or applications. A high code rate can be determined based on a threshold or a range, such as above 1/3 code rate. The same type of data can have its RLC ARQ disabled or can have its RLC retransmissions attempts set or limited to 1. In other examples, low-latency, low-loss and high data rate traffic can have its encoding for error protection set to medium or high code rate, while its PDU configurations can be set using any combination of configurations. For instance, the PDU configuration can include implementation of an early RLC retransmission to allow the XR service to meet its PDB/PSDB requirements. In the implementation of this configuration, a PDB of a defined millisecond(s) value (X) and a default number of RLC retransmissions (N) can be used to define a ratio value (K) as the floor value of (X/N). The system can then perform RLC SDU retransmissions at every ratio value K millisecond interval to make sure that RLC retransmissions occur one or more times within the PDB. In doing so, the system may avoid relying on ARQ or other status acknowledgements or polling and risking not meeting the PDB or other delay thresholds. This approach can also ensure that PDB or PSDB is met, without wasting resources.

For instance, the PDU configuration can implement an early RLC discard protocol. In particular, when the SDUs arrival time exceeds the PDB or PSDB, the packets may not be useful, which can trigger usage of a configuration to discard the PDUs or SDUs that are no longer useful. In such a configuration, the RLC SDUs can be discarded in response to the SDUs being discarded by the PDCP layer or if the PDB/PSDB is exceeded or is determined that it will be exceeded. The PDU configuration can facilitate efficient resource utilization by avoiding unnecessary retransmission of packets that would not provide any benefits upon reception, as provided in Table 1 below:

TABLE 1
Example encodings and PDU Configurations for various PDU types.

| PDU Types | XR Traffic | Determinations | Encodings and PDU Configurations |
|---|---|---|---|
| Low- | XR video | The traffic type is | Encode with medium or high |
| latency, | with lower | tolerant to packet loss | rate for error protection. (e.g., |
| loss- | importance | and errors. Hence, it can | 4/5, 3/4 or 1/2). |
| tolerant | (e.g., P | be protected with low | Disable RLC ARQ or set RLC |
| traffic | frames) | code rate and ARQ can | retransmission attempts to 1. |
| | | be disabled to set with a | |
| | | lower number of | |
| | | retransmission attempts. | |
| Low- | XR video | This traffic is low-loss | Encode with medium or high |
| latency, | with higher | and of high data rate type | rate for error protection. (e.g., |
| low-loss, | importance | traffic. Due to high data | 4/5, 3/4 or 1/2) |
| high data | (e.g., I | rate it can be costly to | PDU Configuration 1: enable |
| rate traffic | frames) | protect the original | early RLC retransmission. (e.g., |
| | | transmission. Hence, it | given a PDB of X ms and a |
| | | can be encoded with | default number of RLC |
| | | medium or high code rate | retransmissions N, define K as |
| | | and rely on having | the floor value of (X/N) and |
| | | efficient ARQ | perform RLC SDU |
| | | retransmissions. | retransmissions at every Kms |
| | | | interval - without relying on |
| | | | polling or status report). |
| | | | PDU Configuration 2: enable |
| | | | early RLC discard (e.g., if the |
| | | | SDUs are discarded by the |
| | | | PDCP or if the PDB/PSDB is |
| | | | exceeded, discard the RLC |
| | | | SDUs). |
| Low- | XR pose or | The traffic is a low-loss | Encode with low code rate for |
| latency, | control data | and a low data rate type | error protection. (e.g., 1/4, 1/5 |
| low-loss, | | traffic. Hence, it can rely | or 1/8) |
| low data | | on low code rate for its | PDU Configuration 1: enable |
| rate traffic | | original transmission as | early RLC retransmission.(e.g., |
| | | well as have efficient | see above). |
| | | ARQ retransmissions. | PDU Configuration 2: enable |
| | | | early RLC discard (e.g., see |
| | | | above). |

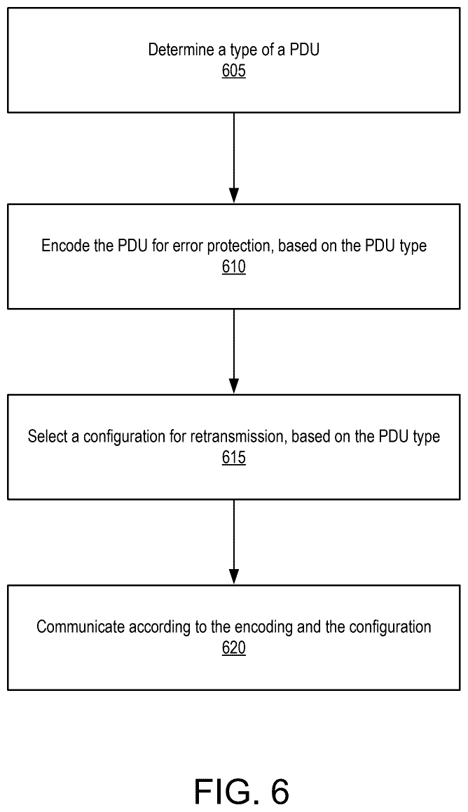

FIG. 6 is a flowchart showing an example method 600 for radio link control for latency service services. The method 600 can be a method for providing error protection encoding and RLC retransmission configurations for XR application PDUs based on the types of PDUs. The method 600 may be performed or executed by the devices, components, elements, or hardware described above with reference to FIG. 1-FIG. 5. For instance, the method 600 can be performed using instructions, computer code and data stored in memory coupled with one or more processors, such as that the instructions, computer code and data, upon execution by the one or more processors, cause the one or more processors to implement the functionalities, steps, actions or operations of the technical solutions. As a brief overview, at action 605, the method can include one or more processors of a sender device determining a type of a PDU. At action 610, the method can include the one or more processors encoding the PDU for error protection, based on the PDU type. At action 615, the method can include the one or more processors selecting a configuration for retransmission, based on the PDU type. At action 620, the method can include the sender device and a receiving device communicating according to the encoding and the configuration.

At action 605, the method can include one or more processors of a sender device determining a type of a PDU. The method can include a processor of a sender device determining whether a protocol data unit (PDU) of an extended reality (XR) application to be transmitted via a radio link control (RLC) layer corresponds to a low-loss traffic or a loss-tolerant traffic. The PDU classifier of the sender device can monitor the traffic output from the XR application utilized by or executed or operating on the sender device (e.g., a UE, computer, laptop, tablet, console or a head mounted device). The XR application output traffic can include SDUs or PDUs, such as SDUs or PDUs corresponding to XR video inter-coded picture frames or I frames, XR video predicted picture or P frames. The XR application output traffic can include XR pose (e.g., head movement, gesture data) or control data (e.g., joystick signals or controls), any of which can be indicated or correspond to low-latency data.

The one or more processors of the sender device can execute a PDU classifier that can utilize various functionalities to determine PDU types of each of the PDUs. For instance, the PDU classifier can determine that a PDU provided by the XR application corresponds to the loss-tolerant traffic and a low-latency traffic. For instance, this determination can be made by analyzing the latency expectations of the XR application and comparing them to predefined thresholds. For example, if the latency expectation is below 30 milliseconds, the PDU can be classified as low-latency traffic. For instance, the PDU classifier can assess the error tolerance of the traffic by evaluating the acceptable packet loss rate. If the packet loss rate is above a certain threshold, such as 3% or 5%, the traffic can be deemed loss-tolerant (e.g., depending on the application or system configuration). For example, the method can include examining the type of data being transmitted, such as XR video traffic with less importance, such as predicted pictures (P frames), which can be classified as loss-tolerant and low-latency traffic based on the type of the data identified (e.g., P frame).

The PDU classifier can determine that the PDU of the XR application corresponds to the low-loss traffic and a high data rate traffic. This can be achieved by evaluating the data rate of the traffic and comparing it to predefined thresholds, either for low-loss determination or high data rate traffic determination. For example, if the data rate exceeds a threshold of 10 Mbps, the traffic can be classified as high data rate. For example, the PDU classifier can assess the error protection requirements by analyzing the acceptable packet loss rate. If the packet loss rate is below a certain packet loss rate threshold, such as 1%, 0.5% or 1.5%, the traffic can be deemed low-loss, depending on the application or configuration of the system. For instance, method can include examining the type of data being transmitted, such as XR video traffic with high importance, which can include intra-coded frames (I frames), which can be classified as low-loss and high data rate traffic, based on their identified type of data (e.g., I frames).

The PDU classifier can determine that the PDU of the XR application corresponds to the low-loss traffic and a high data rate traffic. This determination can be implemented by evaluating the data rate of the traffic and comparing the data rate to predefined thresholds for the rates of data. For example, if the data rate is below a threshold of 1 Mbps, the traffic can be classified as low data rate. For instance, the PDU classifier can assess the error protection requirements by analyzing the acceptable packet loss rate. If the packet loss rate is below a certain packet loss threshold, such as 1% or 0.1%, the traffic can be deemed low-loss traffic. For instance, a method can include examining the type of data being transmitted, including determining the type of the data (e.g., XR pose or control data), which can be classified as low-loss and low data rate traffic, based on the identified type of the data (e.g., pose or control data).

At action 610, the method can include the one or more processors encoding the PDU for error protection, based on the PDU type. The method can include the sender device executing (e.g., via one or more processors) a PDU encoder that can encode the PDU for error protection. The PDU encoder can encode the XR application PDUs according to the of the PDU type. For instance, the encoder can select or apply a particular encoding to the PDU based on identifying or determining the PDU type (e.g., whether the PDU is low-latency and loss-tolerant, or low latency and low-loss). For instance, the PDU encoder can encode the PDU with a medium code rate (e.g., 1/3 code rate) or a high code rate (e.g., 2/3 code rate) in response to the PDU type being determined or identified as being, or corresponding to, low-latency and loss-tolerant traffic. The PDU encoder can encode the PDU with a medium code rate (e.g., 1/3 code rate) or a high code rate (e.g., 2/3 code rate) in response to the PDU type being determined or identified as being, or corresponding to, low-latency, low-loss and high data rate traffic. The PDU encoder can encode the PDU with a low code rate (e.g., 1/6 code rate) in response to the PDU type being determined or identified as being, or corresponding to, low-latency, low-loss and low data rate traffic.

For example, the method can include the PDU classifier of the sender device determining that the PDU corresponds to the loss-tolerant traffic and a low-latency traffic. The PDU encoder of the sender device can encode, responsive to the determination that the PDU corresponds to the loss-tolerant traffic and the low-latency traffic, the PDU for error protection using a code rate that satisfies a threshold for one of a medium code rate or a high code rate for error protection. Depending on the configuration or application of the system, the threshold can be any threshold, such as 4/5, 2/3 or 1/2 rates.

For example, the method can include the PDU classifier of the sender device determining that the PDU corresponds to the low-loss traffic and a high data rate traffic. The PDU encoder can then encode, responsive to the determination that the PDU corresponds to the low-loss traffic and the high data rate traffic, the PDU for error protection using a code rate exceeding a threshold for a medium code rate for error protection. Depending on the configuration or application of the system, the threshold can be any threshold, such as 1/2, 3/5 or 4/7 rates.

For example, the PDU classifier of the sender device can determine that the PDU corresponds to the low-loss traffic and a low data rate traffic. Responsive to the determination that the PDU corresponds to the low-loss traffic and the low data rate traffic, the PDU encoder can encode the PDU for error protection using a code rate that satisfies a threshold for a low code rate for error protection. Depending on the configuration or application of the system, the threshold can be any threshold, such as 1/3, 1/4 or 1/6 rates.

At action 615, the method can include the one or more processors selecting a configuration for retransmission, based on the PDU type. The method can include the one or more processors executing the PDU configuration manager to select, from a plurality of configurations for retransmission, a configuration for retransmission of the PDU. The selection can be made according to the determination whether the PDU of the XR application to be transmitted corresponds to a low-loss traffic or loss-tolerant traffic. The selection can be made responsive to the determination of whether the PDU corresponds to any one or more of: low-latency traffic, loss-tolerant traffic, low-loss traffic, high data rate traffic, or low data rate traffic.

For instance, the sender device can determine that the PDU corresponds to the loss-tolerant traffic and a low-latency traffic. Responsive to the determination that the PDU corresponds to the loss-tolerant traffic and the low-latency traffic, the sender device can disable the ARQ operation of the AM of the RLC layer for error control of transmission of the PDU to a receiving device. The method can include determining that the PDU corresponds to the loss-tolerant traffic and a low-latency traffic. The method can set, responsive to the determination that the PDU corresponds to the loss-tolerant traffic and the low-latency traffic, the configuration for a number of allowed RLC retransmissions to a predetermined value indicating a maximum number of allowed RLC retransmissions. The predetermined value can be any value, such as one or two.

The method can include determining that the PDU corresponds to the low-loss traffic and a high data rate traffic. The method can include determining a time interval within a packet delay budget (PDB) based on a time duration of the PDB and a number of RLC retransmissions. The method can include setting, responsive to the determination that the PDU corresponds to the low-loss traffic and the high data rate traffic, the configuration to initiate RLC retransmissions according to the time interval. For instance, the method can set the configuration to cause the RLC retransmissions to be automatically transmitted every K time interval within the PDB time period. The time interval K can be determined based on K=PDB time period X ms divided by the predetermined number of RLC retransmissions.

The method can include determining that the PDU corresponds to the low-loss traffic and a high data rate traffic. The method can include determining a time interval within a packet delay budget (PDB) based on a time duration of the PDB and a number of RLC retransmissions. The method can include setting the configuration to initiate RLC retransmissions according to the time interval. The configuration can be set responsive to the determination that the PDU corresponds to the low-loss traffic and the high data rate traffic. The time interval (e.g., K) can be determined by dividing the time duration of the PDB by the number of RLC retransmissions. If the number of RLC retransmissions is 4 and PDB time period is 40 ms, then K time interval is 40 ms/4=10 ms. In such configuration, the RLC retransmissions can occur every 10 ms within the 40 ms PDB period.

The method can include determining that at least one of the PDB or PDU set delay budget (PSDU) is exceeded for one or more service data units (SDUs) corresponding to one or more PDUs to be transmitted. The method can include the PDU configuration manager discarding, responsive to the at least one of the PDB or PSDU being exceeded, the one or more SDUs. The method can include determining that a packet data convergence protocol (PDCP) discarded one or more service data units (SDUs) for one or more PDUs to be transmitted. The method can include the PDU configuration manager discarding one or more corresponding SDUs at the RLC. The SDUs can be discarded at the RLC responsive to the determination that the PDCP discarded the one or more SDUs.

The method can include the sender device determining that the PDU corresponds to the low-loss traffic and a low data rate traffic. The method can include the PDU configuration manager determining a time interval within a packet delay budget (PDB) based on a time duration of the PDB and a number of RLC retransmissions. For instance, the time interval can be a time interval determined by dividing the time period of the PDB by a predetermined or configured value of the RLC retransmissions. The PDU configuration manager can set the configuration to initiate RLC retransmissions according to the time interval. The configuration can be set responsive to the determination that the PDU corresponds to the low-loss traffic and the low data rate traffic.

The method can include determining that the PDU corresponds to the low-loss traffic and a low data rate traffic. The method can include determining that at least one of the PDB or a PDU set delay budget (PSDU) is exceeded for one or more service data units (SDUs) for one or more PDUs to be transmitted. The method can include discarding the one or more SDUs. The one or more SDUs can be discarded responsive to the at least one of the PDB or PSDU being exceeded and the PDU corresponding to the low-loss traffic and the low data rate traffic.

At action 620, the method can include the sender device and a receiving device communicating according to the encoding and the configuration. The sender device and the receiver device can communicate with each other using the encoding of the PDU encoder of the sender and the PDU configurations of the PDU configuration manager of the sender device. The sender device can send a message with information comprising the PDU encoding and the PDU configuration to the receiver device. The method can include configuring an encoder with an encoding of the PDU for error protection according to the determination. The method can include synchronizing the encoding with a decoder of a receiving device configured to receive the PDU.

The method can include the receiver device acknowledging the receipt of the PDU and providing feedback to the sender device. The receiver device can utilize its PDU decoder to decode the received PDU based on the encoding information provided by the sender device. If the PDU is successfully decoded and meets the error protection criteria, the receiver device can send an acknowledgment (ACK) back to the sender device. In cases where the PDU is not successfully decoded or errors are detected, the receiver device can send a negative acknowledgment (NACK) to the sender device, prompting a retransmission of the PDU according to the predefined PDU configuration. In some instances, the receiver device can configure the PDU communications to determine to not send ACK or NACK transmissions unless RLC retransmissions requests are received from the sender device.

For instance, the method can include the sender device managing retransmissions and discards based on the feedback received from the receiver device. If a NACK is received, the sender device can initiate a retransmission of the PDU within the time interval defined by the PDU configuration. The sender device can also monitor the Packet Delay Budget (PDB) and PDU Set Delay Budget (PSDB) to ensure that retransmissions occur within the acceptable time frame. If the PDB or PSDB is exceeded, the sender device can discard the PDU to avoid unnecessary retransmissions and conserve resources.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B,’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device, comprising:
one or more processors configured to:
determine whether a protocol data unit (PDU) of an extended reality (XR) application to be transmitted via a radio link control (RLC) layer corresponds to a low-loss traffic or a loss-tolerant traffic;
encode the PDU for error protection, according to the determination; and
select, from a plurality of configurations for retransmission, a configuration for retransmission of the PDU, according to the determination.

2. The device of claim 1, wherein the one or more processors are configured to:
determine that the PDU corresponds to the loss-tolerant traffic and a low-latency traffic;
encode, responsive to the determination that the PDU corresponds to the loss-tolerant traffic and the low-latency traffic, the PDU for error protection using a code rate that satisfies a threshold for one of a medium code rate or a high code rate for error protection.

3. The device of claim 1, wherein the one or more processors are configured to:
determine that the PDU corresponds to the loss-tolerant traffic and a low-latency traffic;
disable, responsive to the determination that the PDU corresponds to the loss-tolerant traffic and the low-latency traffic, automatic repeat request (ARQ) operation of an acknowledged mode (AM) of the RLC layer for error control of transmission of the PDU to a receiving device.

4. The device of claim 1, wherein the one or more processors are configured to:
determine that the PDU corresponds to the loss-tolerant traffic and a low-latency traffic;
set, responsive to the determination that the PDU corresponds to the loss-tolerant traffic and the low-latency traffic, the configuration for a number of allowed RLC retransmissions to a predetermined value indicating a maximum number of allowed RLC retransmissions.

5. The device of claim 4, wherein the predetermined value is one.

6. The device of claim 1, wherein the one or more processors are configured to:
determine that the PDU corresponds to the low-loss traffic and a high data rate traffic;
encode, responsive to the determination that the PDU corresponds to the low-loss traffic and the high data rate traffic, the PDU for error protection using a code rate exceeding a threshold for a medium code rate for error protection.

7. The device of claim 1, wherein the one or more processors are configured to:
determine that the PDU corresponds to the low-loss traffic and a high data rate traffic;
determine a time interval within a packet delay budget (PDB) based on a time duration of the PDB and a number of RLC retransmissions;
set, responsive to the determination that the PDU corresponds to the low-loss traffic and the high data rate traffic, the configuration to initiate RLC retransmissions according to the time interval.

8. The device of claim 7, wherein the time interval is determined by dividing the time duration of the PDB by the number of RLC retransmissions.

9. The device of claim 7, wherein the one or more processors are configured to:
determine that at least one of the PDB or PDU set delay budget (PSDU) is exceeded for one or more service data units (SDUs) corresponding to one or more PDUs to be transmitted; and
discard, responsive to the at least one of the PDB or PSDU being exceeded, the one or more SDUs.

10. The device of claim 7, wherein the one or more processors are configured to:
determine that a packet data convergence protocol (PDCP) discarded one or more service data units (SDUs) for one or more PDUs to be transmitted; and
discard, responsive to the determination that the PDCP discarded the one or more SDUs, one or more corresponding SDUs at the RLC.

11. The device of claim 1, wherein the one or more processors are configured to:
determine that the PDU corresponds to the low-loss traffic and a low data rate traffic;
encode, responsive to the determination that the PDU corresponds to the low-loss traffic and the low data rate traffic, the PDU for error protection using a code rate that satisfies a threshold for a low code rate for error protection.

12. The device of claim 1, wherein the one or more processors are configured to:
determine that the PDU corresponds to the low-loss traffic and a low data rate traffic;
determine a time interval within a packet delay budget (PDB) based on a time duration of the PDB and a number of RLC retransmissions;
set, responsive to the determination that the PDU corresponds to the low-loss traffic and the low data rate traffic, the configuration to initiate RLC retransmissions according to the time interval.

13. The device of claim 1, wherein the one or more processors are configured to:
determine that the PDU corresponds to the low-loss traffic and a low data rate traffic;
determine that at least one of the PDB or a PDU set delay budget (PSDU) is exceeded for one or more service data units (SDUs) for one or more PDUs to be transmitted; and
discard, responsive to the at least one of the PDB or PSDU being exceeded and the PDU corresponding to the low-loss traffic and the low data rate traffic, the one or more SDUs.

14. The device of claim 1, wherein the one or more processors are configured to:
configure an encoder of the device with an encoding of the PDU for error protection according to the determination; and
synchronize the encoding with a decoder of a receiving device configured to receive the PDU.

15. A method, comprising:
determining, by one or more processors, whether a protocol data unit (PDU) of an extended reality (XR) application to be transmitted via a radio link control (RLC) layer corresponds to a low-loss traffic or a loss-tolerant traffic;
encoding, by the one or more processors, the PDU for error protection, according to the determination; and
selecting, by the one or more processors, from a plurality of configurations for retransmission, a configuration for retransmission of the PDU, according to the determination.

16. The method of claim 15, comprising:
determining, by the one or more processors, that the PDU corresponds to the loss-tolerant traffic and a low-latency traffic;
encoding, by the one or more processors, responsive to the determination that the PDU corresponds to the loss-tolerant traffic and the low-latency traffic, the PDU for error protection using a code rate that satisfies a threshold for one of a medium code rate or a high code rate for error protection; and
disabling, by the one or more processors, responsive to the determination that the PDU corresponds to the loss-tolerant traffic and the low-latency traffic, automatic repeat request (ARQ) operation of an acknowledged mode (AM) of the RLC layer for error control of transmission of the PDU to a receiving device.

17. The method of claim 15, comprising:
determining, by the one or more processors, that the PDU corresponds to the loss-tolerant traffic and a low-latency traffic; and
setting, by the one or more processors, responsive to the determination that the PDU corresponds to the loss-tolerant traffic and the low-latency traffic, the configuration for a number of allowed RLC retransmissions to a predetermined value indicating a maximum number of allowed RLC retransmissions, wherein the predetermined value is one.

18. The method of claim 15, comprising:
determining, by the one or more processors, that the PDU corresponds to the low-loss traffic and a high data rate traffic;
determining, by the one or more processors, a time interval within a packet delay budget (PDB) based on a time duration of the PDB and a number of RLC retransmissions; and
setting, by the one or more processors, responsive to the determination that the PDU corresponds to the low-loss traffic and the high data rate traffic, the configuration to initiate RLC retransmissions according to the time interval, wherein the time interval is determined by dividing the time duration of the PDB by the number of RLC retransmissions.

19. The method of claim 15, comprising:
determining, by the one or more processors, that the PDU corresponds to the low-loss traffic and a low data rate traffic;
encoding, by the one or more processors, responsive to the determination that the PDU corresponds to the low-loss traffic and the low data rate traffic, the PDU for error protection using a code rate that satisfies a threshold for a low code rate for error protection;
determining, by the one or more processors, a time interval within a packet delay budget (PDB) based on a time duration of the PDB and a number of RLC retransmissions; and
setting, by the one or more processors, responsive to the determination that the PDU corresponds to the low-loss traffic and the low data rate traffic, the configuration to initiate RLC retransmissions according to the time interval.

20. A device receiving protocol data units (PDUs) from a remote device, comprising:
one or more processors configured to:
receive, from a remote device, information on whether a protocol data unit (PDU) of an extended reality (XR) application to be transmitted via a radio link control (RLC) layer corresponds to a low-loss traffic or a loss-tolerant traffic;
decode the PDU for error protection, according to the information; and
select, from a plurality of configurations for retransmission, a configuration for retransmission of the PDU from the remote device, according to the information.
